(19) United States
(12) Patent Application Publication
(10) Pub. No.: US 2015/0156970 A1
(43) Pub. Date: Jun. 11, 2015

(54) CROP THRESHING METHOD

(71) Applicants: Zharylkasyn Sadykov, Almaty (KZ); Tlektes Espolov, Almaty (KZ); Eduard Zhalnin, Moscow (RU); Shohan AlPeysov, Kurmangazy (KZ); Saule Sadykova, Almaty (KZ)

(72) Inventors: Zharylkasyn Sadykov, Almaty (KZ); Tlektes Espolov, Almaty (KZ); Eduard Zhalnin, Moscow (RU); Shohan AlPeysov, Kurmangazy (KZ); Saule Sadykova, Almaty (KZ)

(21) Appl. No.: 13/978,533

(22) PCT Filed: Dec. 21, 2011
(86) PCT No.: PCT/KZ11/00020

§ 371 Date: Feb. 14, 2014

(30) Foreign Application Priority Data
Jan. 5, 2011 (KZ) 2011/0005.1

(51) Int. Cl. A01F 7/02; A01F 12/00; A01D 41/12; A01F 12/22

(52) U.S. Cl. CPC A01F 7/02; A01F 12/22; A01F 12/00; A01D 41/12

(57) ABSTRACT

Methods for threshing crops by magnetically treating the freshly threshed seeds in order to alter their biophysical, biochemical and physicochemical properties. The methods can be used in agriculture to magnetize seeds when threshing different types of crops during harvesting. In the crop threshing method which includes threshing to separate the mass of grain and chaff into an edible portion and a non-grain portion of the crop, the freshly threshed edible portion of the harvest is magnetically treated during the threshing process using a classic beater-type threshing drum. Magnetic treatment of the edible portion of the crop increases the germinating ability, yield and quality of crops and extends their storage life without loss of quality.

### CROSS-REFERENCE TO RELATED APPLICATION

This application claims the benefit of the priority filing date in PCT/KZ2011/000020 referenced in WIPO Publication No. WO2012/115494. The earliest priority date claimed is Jan. 5, 2011

### FEDERALLY SPONSORED RESEARCH

None

### SEQUENCE LISTING OR PROGRAM

None

### BACKGROUND

The invention relates to methods for threshing crops by magnetically treating the freshly threshed seeds in order to alter their biophysical, biochemical and physicochemical properties, and can be used in agriculture to magnetize seeds when threshing different types of crops during harvesting.

Known is the method for threshing and harvesting of crops wherein plants are cut by a combine harvester header and threshed with the thresher operating in a “sparing” mode [Sadykov, Zh.S. patent KZ No. 1131, A01D 91/04, 45/30, published Sep. 15, 1994, Bulletin No. 3].

However, the use of the known threshing method when harvesting hard-to-thresh crops results in substantial loss of grain due to underthreshing, resulting in harvest shortfall.

The closest to the proposed method in its technical essence is the crop threshing method wherein threshing is conducted by separating the mass of grain and chaff into the edible portion and the non-grain portion of the crop, informally classified as a combine harvester's threshing mechanism working process [Zhalnin, E.V. [Axiomatization of Agricultural Mechanics (Basic Terms)], M, VIM, 2002, p. 150-168]. The authors have selected this method as the prototype.

However, the known method for threshing seed and grain crops also results in grain loss due to grain crushing and micro-damage which results in reduced seed germinating ability crop yield, with 10% of micro-damaged grain for every 1% of crushed grain resulting in reduced seed germinating ability and reduced yield.

Also known is the method for treating seeds by exposing them to an electromagnetic field, where it is possible to cause an acceleration of certain biochemical reactions and thus facilitate alteration of a number of biophysical, biochemical and physicochemical properties. In particular, it is known that by applying an electromagnetic field, for instance, in the 3-30 Hz band, it is possible to increase seed germinating ability and crop yield (see, for instance, patents RU Nos. 2179792, 2134944, etc.). Also, by applying an electromagnetic field in the same frequency band, it is possible to accelerate the processes of extraction from root crops, particularly from sugar beets, and increase sugar yield and the storage life of beets (see patents RU Nos. 2172094, 2172091, 2172095, 2172096, etc.).

However, all current methods for threshing crops and applying an electromagnetic field to biological objects, such as seeds, are not efficient enough, i.e., there is no threshing method that would take into account biological characteristics of particular freshly threshed seeds that are under particular conditions of movement/transport. To achieve the best result, it is necessary to act on a particular portion of freshly threshed seeds as it is transported to the grain hopper of the combine harvester—the seeds are treated with a special field with parameters that are specially selected for the specific type of a crop. Thus, the invention is new and has no analogues.

The technical objective of the claimed invention is to attempt to take into account specific features of freshly threshed seeds. This is accomplished by selecting a magnetic field with the most efficient parameters, and applying it to a portion of seeds during the threshing process in order to activate or suppress biological processes—i.e., the germinating ability which affects changes in ripening times, increasing the yield and quality of crops, their storage life without loss of quality,—and other processes.

The technical result comes down to expanding the functional capabilities of the crop's threshing method with simultaneous magnetic treatment of the freshly threshed edible portion of the crop in a continuous mode.

### SUMMARY

The objective is achieved as follows. In the crop thrashing method that includes threshing and separating the mass of grain and chaff into the edible portion and the non-grain portion of the crop, the freshly threshed edible portion of the crop is magnetically treated during the threshing process using a classic beater-type threshing drum in a continuous mode.

Furthermore, in the crop threshing method the magnetic treatment of the edible portion of the crop during the threshing process is performed by: increasing the initial speed of the edible crop portion entering the threshing mechanism from 1.8 to 8.0 m/s; increasing the distance between the hammers from 180 to 280 mm and accordingly the number of hammers from 6 to 12; increasing the developed length of the concave; and increasing the drum diameter from 380 to 800 mm with constant developed length of the concave.

Furthermore, in the crop threshing method the magnetic treatment of the edible portion of the crop during the threshing process is performed: with a smaller diameter (380-500 mm) threshing drum with the same concave length and the same feeding of the crop mass; different profiles of drum hammers; with an open drum (there is open space between the hammers and hammer supports) with hammers having a 30°-60° active lead angle; with a closed drum (a solid cylinder) with hammers attached to it that have no active lead angle (under 30°); with increasing concave “free cross-section” (the ratio of the area under the holes to the total concave area) from 0% to 40%; with variable distance between the concave bars from the start to the end of the concave—with larger distance in the first and last zones and smaller distance in the middle part of the concave; so that different magnetic fields act on the edible portion of each crop with optimum parameters for each crop.

### DESCRIPTION

The crop threshing method is carried out using different versions of the traditional threshing technology wherein magnetic fields with optimum parameters are applied to moving freshly threshed portions of seeds.

In the crop threshing method, wherein the threshing is conducted by separating the mass of grain and chaff into the edible portion and the non-grain portion of the crop, the freshly threshed edible portion of the harvest is magnetically treated during the threshing process using a classic beater-type threshing drum in a continuous mode, wherein each crop species (variety) is treated using magnetic field with optimum parameters.

During the magnetic treatment of the edible portion of the crop, as the initial speed of feeding the crop mass to the threshing mechanism increases from 1.8 to 8.0 m/s, the grain separation through the concave increases exponentially up to a certain point; grain underthreshing, straw breakage and unevenness of torque on the drum shaft decrease linearly, wherein at a low speed of feeding the mass to the drum, the difference between the extreme torque values is as high as 50%; increasing the distance between hammers from 180 to 280 mm and accordingly the number of hammers from 6 to 12 has no significant effect on grain crushing, but as the number of hammers increases and the distance between them decreases within the above ranges the underthreshing of the wheat crop mass decreases; the grain separation decreases; power consumption of the threshing process decreases; as the developed length of the concave increases, the grain separation and straw breakage increase significantly (linearly) and grain damage is less intensive while underthreshing substantially decreases; as the drum diameter increases from 380 to 800 mm with constant developed length of the concave, the underthreshing increases, the drum kinetic energy increases, the drum rotation stabilizes due to smaller variation of its angular velocity, and with this, the grain separation and straw breakage decrease while the grain damage is practically unchanged and the likelihood of being wrapped up with straw decreases.

Furthermore, in the magnetic treatment of the edible portion of the crop: with the same concave length and the same feed of the crop mass, smaller diameter (380-500 mm) threshing drums increase grain separation, capture the mass more actively and have lower underthreshing, while the profile of drum hammers has considerable effect on the agricultural features and production performance of the threshing mechanism; an open drum (there is open space between the hammers and hammer supports) with hammers having a 30°-60° active lead angle provides turbulent motion of threshed material in the threshing gap with prevailing longitudinal direction of grain movement from the drum center, which results in increased grain separation compared to other versions of hammer design; a closed drum (a solid cylinder) with hammers attached to it, that have no active lead angle, (under 30°) creates a more or less laminar flow of crop mass in the threshing gap with prevailing tangential direction of grain movement, which causes a decrease of the separation effect and a higher grain damage; the “free cross-section” of the concave (the ratio of the area under the holes to the total concave area) has little effect on the underthresing of grain but as the “free cross-section” increases from 0% to 40% the grain damage decreases considerably, the grain separation increases, the straw breakage increases, and the energy consumption of the process increases; the distance between the concave bars from the start to the end of the concave must be variable, with larger distance in the first and last zones and smaller distance in the middle part of the concave.

Herein, the edible portions of various crops are exposed to different magnetic fields with optimum parameters for each crop.

The positive effect of using the proposed crop threshing method is manifested in activation or suppression of biological processes—particularly the germinating ability which affects the change of ripening times, the increase of crops yield and quality, which affects their storage life without loss of quality—and other processes.

The present invention has the following advantages over the prototype:
the method simplicity is achieved due to the use of traditional processes and versions of threshing the crop mass;
improved quality of treatment of freshly threshed seeds is achieved due to the fact that magnetic field freely permeates the portion of the seeds and treats the entire volume of grain transported by transporting modules and passing through their active and passive zones.

What is claimed:

1. A crop threshing method comprising threshing with separation of grain mass and chaff into an edible portion and a non-grain portion of the crop, wherein during threshing process using a classic beater-type threshing drum, a freshly threshed edible portion of the crop is magnetically treated in a continuous mode.

2. The crop threshing method of claim 1, wherein magnetic treatment of the edible portion of the crop during the threshing process is conducted by increasing initial speed of crop mass fed into a threshing mechanism from 1.8 to 8.0 m/s.

3. The crop threshing method of claim 1, wherein magnetic treatment of the edible portion of the crop during the threshing process is conducted by increasing distance between hammers from 180 to 280 mm and accordingly increasing the number of hammers from 6 to 12.

4. The crop threshing method of claim 1, wherein magnetic treatment of the edible portion of the crop during the threshing process is conducted by increasing the developed length of a concave.

5. The crop threshing method of claim 1, wherein the magnetic treatment of the edible portion of the crop during the threshing process is conducted by increasing the drum diameter from 380 to 800 mm with constant developed length of a concave.

6. The crop threshing method of claim 1, wherein the magnetic treatment of the edible portion of the crop during the threshing process is conducted using a smaller diameter, about 380-500 mm, threshing drum with the same concave length and the same feed of crop mass.

7. The crop threshing method of claim 1, wherein the magnetic treatment of the edible portion of the crop during the threshing process is conducted with various profiles of drum hammers.

8. The crop threshing method of claim 7, wherein the magnetic treatment of the edible portion of the crop during the threshing process is conducted using an open drum, and open space between hammers and hammer supports, with hammers that have a 30°-60° active lead angle.

9. The crop threshing method of claim 7, wherein the magnetic treatment of the edible portion of the crop during the threshing process is conducted using a closed drum, a solid cylinder, with hammers attached to it that have no active lead angle, for example, under 30°.

10. The crop threshing method of claim 1, wherein the magnetic treatment of the edible portion of the crop during the threshing process is conducted by increasing the concave “free cross-section,” the ratio of the area under the holes to the total concave area, from 0% to 40%.

11. The crop threshing method of claim 1, wherein the magnetic treatment of the edible portion of the crop during the threshing process is conducted using variable distance between concave bars from start to end of the concave, with larger distance in first and last zones and smaller distance in a middle part of a concave.

12. The crop threshing method of claim 1, wherein different magnetic fields are applied to the edible portion of each crop with optimum parameters for each crop.
